(19) United States
(12) Patent Application Publication
(10) Pub. No.: US 2024/0296385 A1
(43) Pub. Date: Sep. 5, 2024

(54) DETECTING KEY ITEMS USING LARGE LANGUAGE MACHINE-LEARNED MODELS

(71) Applicant: Maplebear Inc., San Francisco, CA (US)

(72) Inventors: Shishir Kumar Prasad, Fremont, CA (US); Shrikar Archak, Newark, CA (US)

(21) Appl. No.: 18/592,961

(22) Filed: Mar. 1, 2024

Related U.S. Application Data
(60) Provisional application No. 63/488,335, filed on Mar. 3, 2023.

(51) Int. Cl. G06N 20/00; G06N 5/04

(52) U.S. Cl. CPC G06N 20/00; G06N 5/04

(57) ABSTRACT

An online system performs inference in conjunction with a machine-learned language model to determine one or more key items in an order. The system generates a prompt for input to a machine-learned language model. The prompt may specify at least the list of ordered items in the order and a request to infer one or more key items in the order. The system provides the prompt to a model serving system for execution by the machine-learned language model for execution. The system parses the response from the model serving system to extract a subset of items as the one or more key items of the order. The system generates an interface presenting the order of the list of items and one or more indications on the interface that indicate the subset of items are key items of the order.

### CROSS REFERENCE TO RELATED APPLICATIONS

This application claims the benefit of U.S. Provisional Patent Application Ser. No. 63/488,335, filed on Mar. 3, 2023, which is incorporated by reference herein in its entirety.

### BACKGROUND

An online system is an online platform that connects users and retailers. A user can place an order for purchasing items from participating retailers via the online system, with the shopping being done by a personal shopper. After the personal shopper finishes shopping, the items are delivered to the user's address. The order of the customer includes a list of ordered items. Sometimes, certain key items in the order of the customer are not fulfilled because, for example, the item is unavailable or the shopper erroneously picks an incorrect item.

### SUMMARY

In accordance with one or more aspects of the disclosure, an online system performs inference in conjunction with a machine-learned language model to determine one or more key items in an order. The online system receives, from a client device, an order including a list of items ordered from a user of the client device. The online system generates a prompt for input to a machine-learned language model, the prompt specifying at least the list of ordered items in the order and a request to infer one or more key items in the order. The online system provides the prompt to a model serving system for execution by the machine-learned language model for execution. The online system receives, from the model serving system, a response generated by executing the machine-learned language model on the prompt. The online system parses the response from the model serving system to extract a subset of items identified by the model as being the one or more key items of the order. The online system generates, on another client device, an interface presenting the order of the list of items and one or more indications on the interface indicating that the subset of items are key items of the order.

### BRIEF DESCRIPTION OF THE DRAWINGS

FIG. 1A illustrates an example system environment for an online system, in accordance with one or more embodiments.

FIG. 1B illustrates an example system environment for an online system, in accordance with one or more embodiments.

FIG. 2 illustrates an example system architecture for an online system, in accordance with one or more embodiments.

FIG. 3 is an example user interface to present one or more key items in an order, in accordance with one or more embodiments.

FIG. 4 is a flowchart for determining one or more key items in an order, in accordance with one or more embodiments.

### DETAILED DESCRIPTION

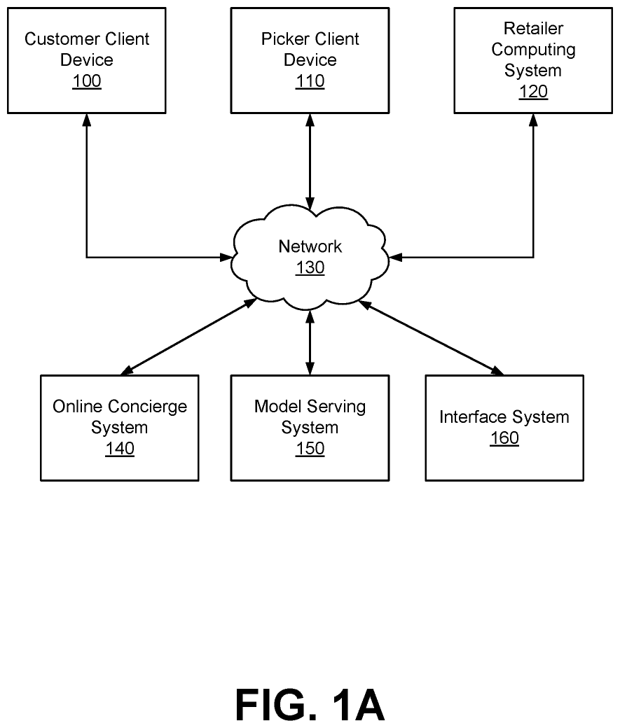

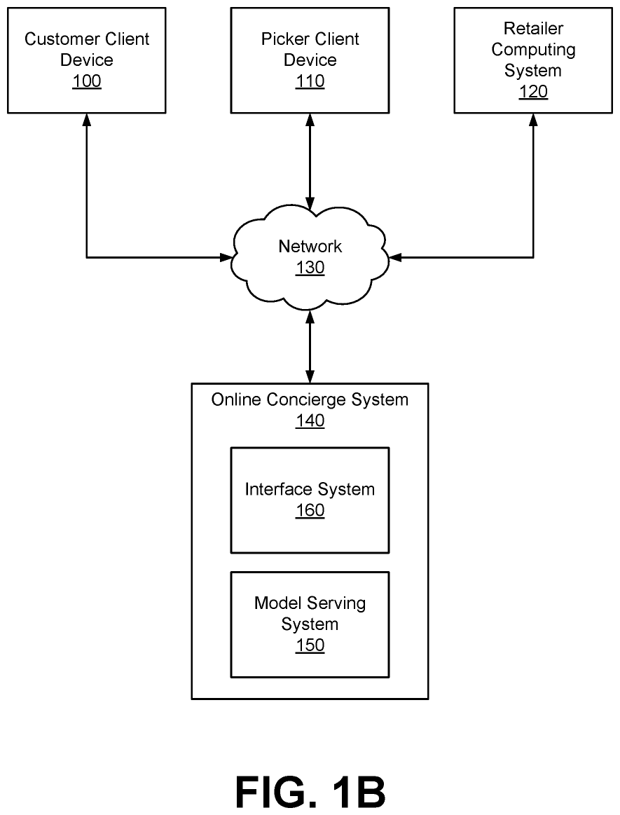

FIG. 1A illustrates an example system environment for an online system 140, in accordance with one or more embodiments. The system environment illustrated in FIG. 1A includes a customer client device 100, a picker client device 110, a retailer computing system 120, a network 130, and an online system 140. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online system 140. Additionally, while one customer client device 100, picker client device 110, and retailer computing system 120 are illustrated in FIG. 1, any number of customers, pickers, and retailers may interact with the online system 140. As such, there may be more than one customer client device 100, picker client device 110, or retailer computing system 120.

The customer client device 100 is a client device through which a customer may interact with the picker client device 110, the retailer computing system 120, or the online system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online system 140.

A customer uses the customer client device 100 to place an order with the online system 140. An order specifies a set of items to be delivered to the customer. An “item”, as used herein, means a good or product that can be provided to the customer through the online system 140. The order may include item identifiers (e.g., a stock keeping unit or a price look-up code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online system 140. The ordering interface may be part of a client application operating on the customer client device 100. The ordering interface allows the customer to search for items that are available through the online system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected.

The customer client device 100 may receive additional content from the online system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item in the retailer location, and may even specify a sequence in which the picker should collect the items for improved efficiency in collecting items. In some embodiments, the picker client device 110 transmits to the online system 140 or the customer client device 100 which items the picker has collected in real time as the picker collects the items.

In one or more embodiments, the collection interface of a picker client device 110 is configured to present the list of ordered items with indications that a subset of the items are key items in the order. Responsive to receiving such indications, a picker presented with the key items can make an increased effort and/or spend more time to find and/or fulfill the key items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. Where a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the customer client device 100 for display to the customer such that the customer can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a computing system operated by a retailer that interacts with the online system 140. As used herein, a “retailer” is an entity that operates a “retailer location,” which is a store, warehouse, or other building from which a picker can collect items. The retailer computing system 120 stores and provides item data to the online system 140 and may regularly update the online system 140 with updated item data. For example, the retailer computing system 120 provides item data indicating which items are available at a retailer location and the quantities of those items. Additionally, the retailer computing system 120 may transmit updated item data to the online system 140 when an item is no longer available at the retailer location. Additionally, the retailer computing system 120 may provide the online system 140 with updated item prices, sales, or availabilities. Additionally, the retailer computing system 120 may receive payment information from the online system 140 for orders serviced by the online system 140. Alternatively, the retailer computing system 120 may provide payment to the online system 140 for some portion of the overall cost of a user's order (e.g., as a commission).

The customer client device 100, the picker client device 110, the retailer computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which customers can order items to be provided to them by a picker from a retailer. The online system 140 receives orders from a customer client device 100 through the network 130. The online system 140 selects a picker to service the customer's order and transmits the order to a picker client device 110 associated with the picker. The picker collects the ordered items from a retailer location and delivers the ordered items to the customer. The online system 140 may charge a customer for the order and provides portions of the payment from the customer to the picker and the retailer.

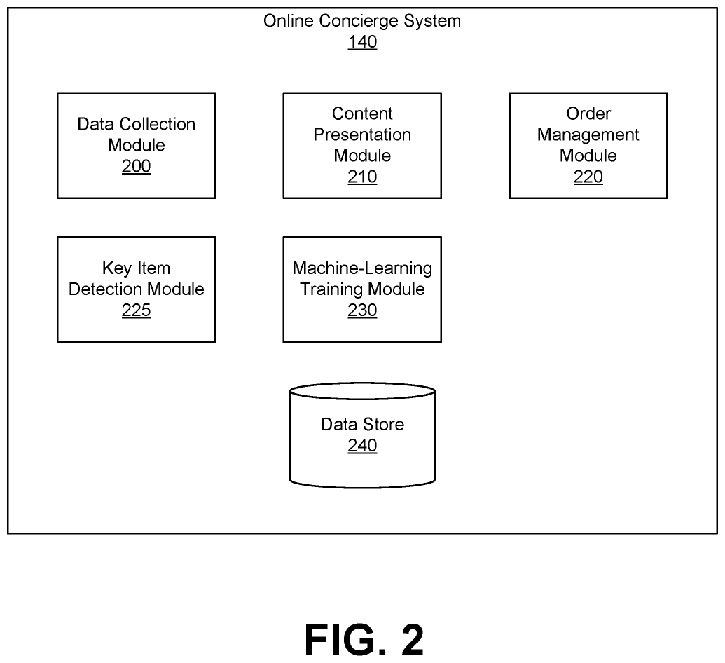

As an example, the online system 140 may allow a customer to order groceries from a grocery store retailer. The customer's order may specify which groceries they want delivered from the grocery store and the quantities of each of the groceries. The customer's client device 100 transmits the customer's order to the online system 140 and the online system 140 selects a picker to travel to the grocery store retailer location to collect the groceries ordered by the customer. Once the picker has collected the groceries ordered by the customer, the picker delivers the groceries to a location transmitted to the picker client device 110 by the online system 140. The online system 140 is described in further detail below with regards to FIG. 2.

The model serving system 150 receives requests from the online system 140 to perform inference tasks using machine-learned models. The inference tasks include, but are not limited to, natural language processing (NLP) tasks, audio processing tasks, image processing tasks, video processing tasks, and the like. In one or more embodiments, the machine-learned models deployed by the model serving system 150 are models configured to perform one or more NLP tasks. The NLP tasks include, but are not limited to, text generation, query processing, machine translation, chatbot applications, and the like. In one or more embodiments, the language model is configured as a transformer neural network architecture. Specifically, the transformer model is coupled to receive sequential data tokenized into a sequence of input tokens and generates a sequence of output tokens depending on the inference task to be performed.

The model serving system 150 receives a request including input data (e.g., text data, audio data, image data, or video data) and encodes the input data into a set of input tokens. The model serving system 150 applies the machine-learned model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learned model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one or more embodiments, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many inference tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units (GPUs) for training or deploying deep neural network models. In one instance, the LLM may be trained and hosted on a cloud infrastructure service. The LLM may be trained by the online system 140 or entities/systems different from the online system 140. An LLM may be trained on a large amount of data from various data sources. For example, the data sources include websites, articles, posts on the web, and the like. From this massive amount of data coupled with the computing power of LLMs, the LLM is able to perform various inference tasks and synthesize and formulate output responses based on information extracted from the training data.

In one or more embodiments, when the machine-learned model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In another embodiment, the transformer architecture may have an encoder-decoder architecture and includes a set of encoders coupled to a set of decoders. An encoder or decoder may include one or more attention operations.

While a LLM with a transformer-based architecture is described as a primary embodiment, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like. The LLM is configured to receive a prompt and generate a response to the prompt. The prompt may include a query and additional contextual information that is useful for responding to the query. The LLM infers the response to the query from the knowledge that the LLM was trained on and/or from the contextual information included in the prompt.

In one or more embodiments, given an order of a user that includes a list of ordered items, the online system 140 performs an inference task in conjunction with the model serving system 150 to detect one or more key items in the order of the user. The key items may be items that have higher importance than other items on a list with respect to, for example, affecting whether a customer will be able to complete one or more recipes, scarcity of the item (e.g., item is key when the item is only available for limited time), and the like. A key item may indicate that the order for that item should be fulfilled with higher importance compared to other items in the order of the customer.

For example, an order of a user may include a list of items including yogurt, biryani masala, ginger garlic paste, salt, pepper, chicken, and the user may have planned to make one or more recipes (e.g., chicken biryani) with the ingredients. In such an example, one or more key ingredients that are deemed important for making the recipe may be chicken and biryani masala. As another example, the user may not have a particular recipe planned, but may be ordering the list of ingredients because they may be potentially used to make different types of recipes (e.g., chicken biryani, chicken salad) in the future. In such an example, chicken may still be considered a key item because the potential recipes cannot be completed without the chicken ingredient. In such an instance, when key items of an order are unfulfilled because, for example, a picker missed the item, the customer may experience greater dissatisfaction compared to when a non-key item in the order was missed.

Thus, in one or more embodiments, when the online system 140 presents the items included in a user's order to a picker in the collection interface of the picker client device 110, the online system 140 may generate indications in the collection interface that indicates the picker should focus on, prioritize, and/or take extra care in fulfilling the one or more identified key items in the order of the customer compared to other items or the order. Since an LLM is trained on a massive amount of training data, the LLM may represent an external database that the online system 140 can leverage to identify key items in an order of a customer. For example, the LLM may determine the key items by mapping the items in an order to potential recipes that can be completed using the ordered items. In this manner, the online system 140 can ensure that the picker fulfilling an order focuses on making sure that a key item or an appropriate substitute item for the key item is delivered to the customer.

In one or more embodiments, the inference task for the model serving system 150 can primarily be based on reasoning and summarization of knowledge specific to the online system 140, rather than relying on general knowledge encoded in the weights of the machine-learned model of the model serving system 150. Thus, one type of inference task may be to perform various types of queries on large amounts of data in an external corpus in conjunction with the machine-learned model of the model serving system 150. For example, the inference task may be to perform question-answering, text summarization, text generation, and the like based on information contained in the external corpus.

Thus, in one or more embodiments, the online system 140 is connected to an interface system 160. The interface system 160 receives an external corpus from the online system 140 and builds a structured index over the data using, for example, another machine-learned language model or heuristics. The interface system 160 receives one or more queries from the online system 140 on the external data. The interface system 160 constructs one or more prompts for input to the model serving system 150. A prompt may include the query of the user and context obtained from the structured index of the external data. In one instance, the context in the prompt includes portions of the structured indices as contextual information for the query. The interface system 160 obtains one or more responses to the query from the model serving system 150 and synthesizes a response. While the online system 140 can generate a prompt using the external data as context, oftentimes, the amount of information in the external data exceeds prompt size limitations configured by the machine-learned language model. The interface system 160 can resolve prompt size limitations by generating a structured index of the data and offers data connectors to external data sources as well as provide a flexible connector to the external corpus.

FIG. 1B illustrates an example system environment for an online system 140, in accordance with one or more embodiments. The system environment illustrated in FIG. 1B includes a customer client device 100, a picker client device 110, a retailer computing system 120, a network 130, and an online system 140. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

The example system environment in FIG. 1A illustrates an environment where the model serving system 150 and/or the interface system 160 are each managed by an entity separate from the entity managing the online system 140. In one or more embodiments, as illustrated in the example system environment in FIG. 1B, the model serving system 150 or the interface system 160 is managed and deployed by the entity managing the online system 140.

FIG. 2 illustrates an example system architecture for an online system 140, in accordance with some embodiments. The system architecture illustrated in FIG. 2 includes a data collection module 200, a content presentation module 210, an order management module 220, a key item detection module 225, a machine learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. In one or more embodiments, the data collection module 200 may only collect data describing a user if the user has previously explicitly consented to the online system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has services orders for the online system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order. In some embodiments, the order data includes user data for users associated with the order, such as customer data for a customer who placed the order or picker data for a picker who serviced the order.

The content presentation module 210 selects content for presentation to a customer. For example, the content presentation module 210 selects which items to present to a customer while the customer is placing an order. The content presentation module 210 generates and transmits the ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine learning model that is trained to score items for a customer based on item data for the items and customer data for the customer. For example, the item selection model may be trained to determine a likelihood that the customer will order the item. In one or more embodiments, the item selection model uses item embeddings describing items and customer embeddings describing customers to score items. These item embeddings and customer embeddings may be generated by separate machine learning models and may be stored in the data store 240.

In one or more embodiments, the content presentation module 210 scores items based on a search query received from the customer client device 100. A search query is free text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In one or more embodiments, the content presentation module 210 scores items based on a predicted availability of an item. The content presentation module 210 may use an availability model to predict the availability of an item. An availability model is a machine learning model that is trained to predict the availability of an item at a retailer location. As an example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

The order management module 220 that manages orders for items from customers. The order management module 220 receives orders from a customer client device 100 and assigns the orders to pickers for service based on picker data. For example, the order management module 220 assigns an order to a picker based on the picker's location and the location of the retailer from which the ordered items are to be collected. The order management module 220 may also assign an order to a picker based on how many items are in the order, a vehicle operated by the picker, the delivery location, the picker's preferences on how far to travel to deliver an order, the picker's ratings by customers, or how often a picker agrees to service an order.

In one or more embodiments, the order management module 220 determines when to assign an order to a picker based on a delivery timeframe requested by the customer with the order. The order management module 220 computes an estimated amount of time that it would take for a picker to collect the items for an order and deliver the ordered item to the delivery location for the order. The order management module 220 assigns the order to a picker at a time such that, if the picker immediately services the order, the picker is likely to deliver the order at a time within the timeframe. Thus, when the order management module 220 receives an order, the order management module 220 may delay in assigning the order to a picker if the timeframe is far enough in the future.

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In one or more embodiments, the order management module 220 obtains a list of key items for an order from the key item detection module 225. When the list of ordered items are presented to the picker client device 110 for fulfillment, the order management module 220 may generate indications that the identified items are key items in the order, such that the picker presented with the items can make an increased effort and/or spend more time to fulfill the key items. In one instance, the indication is a display mechanism that emphasizes the subset of identified key items on the list via, for example, bolded text, icons next to the items, and the like. In another instance, the indication is presentation of the list of items or at least the list of key items in the relative ordering of importance when specified from the key item detection module 225. Thus, the most important item may be presented first to the picker client device 110, and then the second most important item, and so on.

In yet another instance, the order management module 220 may apply additional logic or heuristics to the one or more key items to reflect items that are more business critical than others, for example, certain items that result in higher content-related revenue for the online system 140. For example, given a subset of key items for which one is a beverage of a particular brand, and another item is a food product, the order management module 220 may present the beverage of the particular brand at a higher order (e.g., higher position) on the list responsive to determining that the beverage of the particular brand is more business critical to the online system 140 than the food item.

In one or more embodiments, the order management module 220 tracks the location of the picker within the retailer location. The order management module 220 uses sensor data from the picker client device 110 or from sensors in the retailer location to determine the location of the picker in the retailer location. The order management module 220 may transmit to the picker client device 110 instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the customer with the location of the picker so that the customer can track the progress of their order. In some embodiments, the order management module 220 computes an estimated time of arrival for the picker at the delivery location and provides the estimated time of arrival to the customer.

In one or more embodiments, the order management module 220 facilitates communication between the customer client device 100 and the picker client device 110. As noted above, a user may use a user client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

The key item detection module 225 retrieves orders of customers from the order management module 220, and for a given order including a list of items, infers one or more key items in an order of a customer in conjunction with the model serving system 150. Specifically, the key item detection module 225 generates a prompt that includes a request of the inference task to be performed by the machine-learned model and contextual information for the inference task. In one or more embodiments, the prompt generated by the key item detection module 225 includes a request to infer the key items of an order given a list of ordered items in the order of a customer. An example prompt to an LLM may be:
“Given a list of items: salt, shallots, beef tenderloin, puff” pastry, eggs, which items are the most important for this order?

Another example prompt to the LLM may be:
“Given a list of items: salt, shallots, beef tenderloin, puff pastry, eggs, which items are the most important for this order? Try mapping the list of items to potential food recipes to” determine important items.

In one instance, the key item detection module 225 additionally includes contextual information including, but not limited to, the browsing history of the user during the order session, attributes of the user, and other types of contextual data about the user as collected by the data collection module 200 in the prompt. For example, the browsing history of the user may include an ordered list of websites or pages the customer visited during the ordering session. As another example, the attributes of a user may include profile information such as geographical location, age, gender, and the like of the user. The contextual information provides additional context for determining the key items in a user's order.

In one or more embodiments, the prompt to the machine-learned model further includes a set of examples that guide key item detection, especially when no training data is available to fine-tune the parameters of the machine-learned model. In one instance, the examples are examples of edible items, and are obtained from a collection of recipes. For a given recipe, the list of ingredients for the recipe may represent a hypothetical user's order, and one or more key ingredients are identified for the recipe as the key items.

To identify key items in the recipe, the key item detection module 225 receives a database of recipes, where the database may be an internal database and/or a third-party database. In one instance, the key item detection module 225 performs keyword searching to match ingredients of the recipe to the title of the recipe to items in a user's cart to label potential key items. Since a title of a recipe may reflect key ingredients of the recipe, the ingredients that are reflected in the title are determined as key ingredients, assuming that the whole list of ingredients is a cart of a user's order. The key item detection module 225 obtains a set of recipes, identifies one or more key ingredients in each recipe representing “key items.” The key item detection module 225 includes the set of annotated recipes in the prompt as a guide for detecting key items in the user's order.

In another instance, the examples to guide key item detection may be examples obtained from a user's purchase history. The key item detection module 225 receives the aggregate user's purchase history and normalizes the user's item data with a scaling factor. For a user's order history, the key item detection module 225 can determine for each item, the purchase frequency of the item. After the analysis, the key item detection module 225 can identify a subset of outlier items that have below a threshold percentile (e.g., 25%) purchase frequency, and another subset of outlier items that have over a threshold percentile (e.g., 75%) purchase frequency.

The outliers are removed to obtain a subset of key items that are of interest and focus to the user. From the normalized aggregate list of items, the key item detection module 225 is prompted to determine key items from the user's aggregate history data (e.g., items with SKU's 135, 874, 394). The key item detection module 225 reviews the individual orders of the user, and annotates orders that include the key items. These annotated orders are included in the prompt as examples to guide the model in the prompt. For instance, a key item detection module 225 receives a user's history data where the user routinely orders an item every 2-3 weeks, the key item detection module 225 may label the item as an example key item, after confirming that the item is in the user's current order.

The key item detection module 225 receives an output from the machine-learned model of the model serving system 150 as a response to the prompt. The key item detection module 225 extracts the key items of an order from the output of the machine-learned model and provides the information to the order management module 220. While the output of an LLM may be formatted, for example, in a dialogue format, the key item detection module 225 parses the output to extract meaningful information describing the key items of an order.

As an example, the output of the machine-learned model (e.g., LLM) from the model serving system 150 may be:
“Based on the list provided, the key ingredients are beef tenderloin and puff pastry. Shallots and eggs are common ingredients often added to enhance the flavor of dishes but typically are not considered key ingredients.”

The key item detection module 225 may parse the output from the model serving system 150 to identify beef tenderloin and puff pastry as the key ingredients. In one instance, the key item detection module 225 may extract not only the key items but also a relative ranking between the items that rank each item with respect to their relative importance in the order. For example, the output of the machine-learned model may also specify that the most important item is beef tenderloin and then puff pastry.

The key item detection module 225 may provide the one or more key items of a customer's order and/or the relative rankings of the items to the order management module 220, such that the order management module 220 can generate indications on a picker client device 110. For example, a user interface (UI) may be generated on the picker device highlighting the key items identified in the user's order, such that the picker pays attention to fulfilling key items in the order.

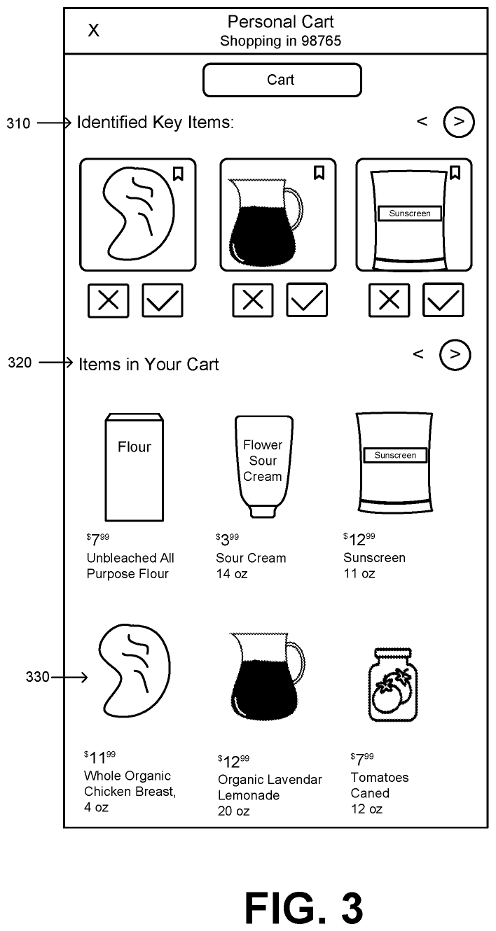

In one or more embodiments, the online system 140 may prompt the user via a UI on whether the inferred key ingredients are actually key ingredients to the user. The UI presented to the user may display a like or dislike UI element that is displayed along with the items in a user's order to confirm or deny the identified key items for the user. The UI feedback provides real-time feedback for the key item detection module 225 to later fine-tune the machine-learned model with. FIG. 3 illustrates a further example of an embodiment of a UI presented to the user, in accordance with one or more embodiments. In response to a positive response from the user regarding an item, the online system 140 may generate the further indications on the picker client device 110.

The online system 140 obtains training data for fine-tuning parameters of the machine-learned model based on the feedback data. In one or more embodiments, the online system 140 identifies positive instances of feedback where users provided positive feedback on key item detection. In another embodiment, the online system 140 identifies the positive instances of feedback as items in which the user did not provide negative feedback on the set of key items presented to the user. For example, a data instance in the training data includes a set of a user's items (e.g., fresh flowers, chicken breasts, flour, chocolate chips), and/or context describing the user (e.g., holiday and weather data describing the user) as inputs. The expected outputs comprise of the confirmed key items for the user's order (e.g., the items in which the user positively confirms the key items).

The online system 140 applies the parameters of the machine-learned model to the received feedback data inputs and then generates some estimated outputs. The online system 140 compares the estimated key items from the machine-learned model with the expected output for the training instance to obtain a loss function. The online system 140 obtains one or more error terms from the loss function, and backpropagates the error terms to update the parameters of the machine-learned model.

FIG. 3 describes an embodiment of the UI presented to the client device associated with the user to confirm the identified key items. The UI presents a cart for the user that includes the items in the user's cart 320 and the identified key items 310. The identified key items 310 additionally include UI elements for the user to provide feedback for the identified key item 330, in which user interaction with the checkmark symbol is a positive feedback signal and user interaction with the cross symbol is a negative feedback signal.

In one or more embodiments, the key item detection module 225 may perform an iterative training or fine-tuning process, where the machine-learned model is initially fine-tuned with data instances obtained from previous orders of users and items inferred to be key items in the orders, the set of example recipes annotated with key ingredients, or previous orders annotated with key items (i.e., from the statistical analysis) from the user's order history. For a new order, the machine-learned model may generate estimates of key items in the order, and the user may provide feedback on whether the inferred key items are in fact key items. Based on the feedback, the key item detection module 225 may retrain or re-fine-tune the machine-learned model with the updated training dataset to reduce errors, e.g., false positives or false negatives for key item detection.

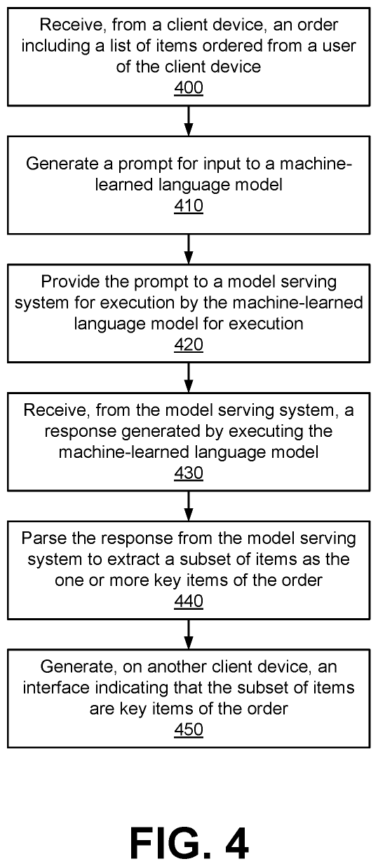

FIG. 4 illustrates a flowchart describing detection of detecting key items in a user's order, in accordance with one or more embodiments. The key item detection module 225 receives 400 from a client device, an order including a list of items ordered from a user of the client device and generates 410 a prompt to a machine-learned language model where the prompt includes instructions to identify key items from a received set of inputs. The key item detection module 225 provides 420 the prompt to a model serving system 150 with the response from the machine learned language model for execution and receives 430 the response from the model serving system for the machine learned language model. The key item detection module 225 parses 440 the response from the model serving system to extract a subset of items as the one or more key items of the order and generates 450 on another client device, an interface indicating that the subset of items are key items of the order.

The machine learning training module 230 trains machine learning models used by the online system 140. For example, the machine learning module 230 may train the item selection model, the availability model, or any of the machine-learned models deployed by the model serving system 150. The online system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. For example, each training example may include customer data, picker data, item data, or order data. In some cases, the training examples also include a label which represents an expected output of the machine learning model. In these cases, the machine learning model is trained by comparing its output from input data of a training example to the label for the training example.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross entropy loss function. The machine learning training module 230 updates the set of parameters for the machine learning model based on the score generated by the loss function. For example, the machine learning training module 230 may apply gradient descent to update the set of parameters.

The data store 240 stores data used by the online system 140. For example, the data store 240 stores customer data, item data, order data, and picker data for use by the online system 140. The data store 240 also stores trained machine learning models trained by the machine learning training module 230. For example, the data store 240 may store the set of parameters for a trained machine learning model on one or more non-transitory, computer-readable media. The data store 240 uses computer-readable media to store data, and may use databases to organize the stored data.

With respect to the machine-learned models hosted by the model serving system 150, the machine-learned models may already be trained by a separate entity from the entity responsible for the online system 140. In another embodiment, when the model serving system 150 is included in the online system 140, the machine-learning training module 230 may further train parameters of the machine-learned model based on data specific to the online system 140 stored in the data store 240. As an example, the machine-learning training module 230 may obtain a pre-trained transformer language model and further fine tune the parameters of the transformer model using training data stored in the data store 240. The machine-learning training module 230 may provide the model to the model serving system 150 for deployment.

### ADDITIONAL CONSIDERATIONS

The foregoing description of the embodiments has been presented for the purpose of illustration; many modifications and variations are possible while remaining within the principles and teachings of the above description. Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method comprising:
receiving, from a client device, an order including a list of items ordered from a user of the client device;
generating a prompt for input to a machine-learned language model, the prompt specifying at least the list of items and a request to infer one or more key items in the order;
providing the prompt to a model serving system for execution by the machine-learned language model for execution;
receiving, from the model serving system, a response generated by executing the machine-learned language model on the prompt;
parsing the response from the model serving system to extract information identifying a subset of items as being the one or more key items of the order; and
sending, to another client device, the order of the list of items and one or more indications that the subset of items are key items of the order, the sending further comprising causing display of an interface including the list of items and the one or more indications on the another client device.

2. The method of claim 1, further comprising:
obtaining a set of recipes from a database, each recipe including a title and a list of ingredients for the recipe;
for each recipe, annotating one or more key ingredients based on matching the list of ingredients with the title of the recipe, wherein the prompt includes the annotated recipes.

3. The method of claim 1, further comprising:
obtaining order history for a user and aggregating a list of items in the order history;
identifying a subset of items in the order history as key items;
for each of one or more previous orders of the user, annotating one or more key items in the order; and
providing the prompt comprises including the annotated orders in the prompt.

4. The method of claim 1, further comprising:
generating another interface on the client device presenting the one or more key items; and
for each key item, receiving a positive indication or a negative indication on whether the key item is an actual key item from a user.

5. The method of claim 4, further comprising:
generating a training dataset including a set of data instances, wherein a data instance includes inputs comprising the list of items of the order and expected outputs comprising key items for which positive indication was received from the user; and
fine-tuning parameters of the machine-learned model using the training dataset.

6. The method of claim 4, further comprising:
generating a training dataset including a set of data instances, wherein a data instance includes inputs comprising the list of items of the order, wherein the items include edible and non-edible items.

7. The method of claim 4, wherein receiving the positive indication on whether the key item is an actual key item from a user comprises one of:
receiving an interaction with a positive user interface element presented to the user or receiving an indication of no interaction with a negative user interface element presented to the user.

8. A non-transitory computer readable storage medium comprising stored program code instructions, the instructions when executed causes a processing system to:
receive, from a client device, an order including a list of items ordered from a user of the client device;
generate a prompt for input to a machine-learned language model, the prompt specifying at least the list of items and a request to infer one or more key items in the order;
provide the prompt to a model serving system for execution by the machine-learned language model for execution;
receiving, from the model serving system, a response generated by executing the machine-learned language model on the prompt;
parse the response from the model serving system to extract information identifying a subset of items as being the one or more key items of the order; and
send, to another client device, the order of the list of items and one or more indications that the subset of items are key items of the order, the instructions further causing the processing system to display an interface including the list of items and the one or more indications on the another client device.

9. The computer-readable medium of claim 8, further storing instructions that cause the processor to:
obtain a set of recipes from a database, each recipe including a title and a list of ingredients for the recipe;
for each recipe, annotate one or more key ingredients based on matching the list of ingredients with the title of the recipe, wherein the prompt includes the annotated recipes.

10. The computer-readable medium of claim 8, further storing instructions that cause the processor to:
obtain a order history for a user and aggregate a list of items in the order history;
identify a subset of items in the order history as key items;
for each of one or more previous orders of the user, annotate one or more key items in the order; and
provide the prompt comprises including the annotated orders in the prompt.

11. The computer-readable medium of claim 8, further storing instructions that cause the processor to:
generate another interface on the client device presenting the one or more key items; and
for each key item, receive a positive indication or a negative indication on whether the key item is an actual key item from a user.

12. The computer-readable medium of claim 11, further storing instructions that cause the processor to:
generate a training dataset including a set of data instances, wherein a data instance includes inputs comprising the list of items of the order and expected outputs comprising key items for which positive indication was received from the user; and
fine-tune parameters of the machine-learned model using the training dataset.

13. The computer-readable medium of claim 11, further storing instructions that cause the processor to:
generate a training dataset including a set of data instances, wherein a data instance includes inputs comprising the list of items of the order, wherein the items include edible and non-edible items.

14. The computer-readable medium of claim 11, wherein instructions that cause the processor to receive the positive indication on whether the key item is an actual key item from a user, comprises instructions that cause the processor to do one of:
receive an interaction with a positive user interface element presented to the user or receive an indication of no interaction with a negative user interface element presented to the user.

15. A computer system comprising:
a processor; and
a non-transitory computer-readable medium storing instructions that, when executed by the processor, cause the processor to:
receive, from a client device, an order including a list of items ordered from a user of the client device;
generate a prompt for input to a machine-learned language model, the prompt specifying at least the list of items and a request to infer one or more key items in the order;
provide the prompt to a model serving system for execution by the machine-learned language model for execution;
receiving, from the model serving system, a response generated by executing the machine-learned language model on the prompt;
parse the response from the model serving system to extract information identifying a subset of items as being the one or more key items of the order; and
send, to another client device, the order of the list of items and one or more indications that the subset of items are key items of the order, the instructions further causing the processor to display an interface including the list of items and the one or more indications on the another client device.

16. The computer system of claim 15, further storing instructions that cause the processor to:
obtain a set of recipes from a database, each recipe including a title and a list of ingredients for the recipe;
for each recipe, annotate one or more key ingredients based on matching the list of ingredients with the title of the recipe, wherein the prompt includes the annotated recipes.

17. The computer system of claim 15, further storing instructions that cause the processor to:
obtain a order history for a user and aggregate a list of items in the order history;
identify a subset of items in the order history as key items;
for each of one or more previous orders of the user, annotate one or more key items in the order; and
provide the prompt comprises including the annotated orders in the prompt.

18. The computer system of claim 15, further storing instructions that cause the processor to:
generate another interface on the client device presenting the one or more key items; and
for each key item, receive a positive indication or a negative indication on whether the key item is an actual key item from a user.

19. The computer system of claim 18, further storing instructions that cause the processor to:
generate a training dataset including a set of data instances, wherein a data instance includes inputs comprising the list of items of the order and expected outputs comprising key items for which positive indication was received from the user; and
fine-tune parameters of the machine-learned model using the training dataset.

20. The computer system of claim 18, further storing instructions that cause the processor to:
generate a training dataset including a set of data instances, wherein a data instance includes inputs comprising the list of items of the order, wherein the items include edible and non-edible items.

21. The method of claim 1, wherein the another client device is a client device of a user fulfilling the order.
